(19) United States
(12) Patent Application Publication
(10) Pub. No.: US 2011/0261705 A1
(43) Pub. Date: Oct. 27, 2011

(54) Mapping Traffic Classes to Flow Control Groups

(76) Inventors: Sushil S. Kamerkar, Woodland Hills, CA (US); John Dalmau, Simi Valley, CA (US); Brian Fuchs, Thousand Oaks, CA (US)

(21) Appl. No.: 12/771,647

(22) Filed: Apr. 30, 2010

Related U.S. Application Data
(63) Continuation-in-part of application No. 12/766,704, filed on Apr. 23, 2010.

(51) Int. Cl. H04L 12/26

(52) U.S. Cl. 370/252

(57) ABSTRACT

An apparatus, method, and storage medium for testing a network. A traffic generator may generate and transmit test traffic including a plurality of packet streams associated with a plurality of flow control groups. A traffic receiver may receive flow control packets from the network. Flow control logic may generate traffic class state data indicating a paused/not paused state for each of a plurality of traffic classes in accordance with the received flow control packets. A conversion table may map the traffic class state data into flow control data indicating a paused/not paused state for each of the plurality of flow control groups. The traffic generator may be configured to stop transmission of all packet streams associated with paused flow control groups in accordance with the flow control data.

### RELATED APPLICATION INFORMATION

This patent is a continuation-in-part of the following prior-filed copending non-provisional patent application Ser. No. 12/766,704, filed Apr. 23, 2010, titled Traffic Generator With Priority Flow Control, which is incorporated herein by reference.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to generating traffic for testing a network or network device.

2. Description of the Related Art

In many types of communications networks, each message to be sent is divided into portions of fixed or variable length. Each portion may be referred to as a packet, a frame, a cell, a datagram, a data unit, or other unit of information, all of which are referred to herein as packets.

Each packet contains a portion of an original message, commonly called the payload of the packet. The payload of a packet may contain data, or may contain voice or video information. The payload of a packet may also contain network management and control information. In addition, each packet contains identification and routing information, commonly called a packet header. The packets are sent individually over the network through multiple switches or nodes. The packets are reassembled into the message at a final destination using the information contained in the packet headers, before the message is delivered to a target device or end user. At the receiving end, the reassembled message is passed to the end user in a format compatible with the user's equipment.

Communications networks that transmit messages as packets are called packet switched networks. Packet switched networks commonly contain a mesh of transmission paths which intersect at hubs or nodes. At least some of the nodes may include a switching device or router that receives packets arriving at the node and retransmits the packets along appropriate outgoing paths. Packet switched networks are governed by a layered structure of industry-standard protocols. Layers 1, 2, and 3 of the structure are the physical layer, the data link layer, and the network layer, respectively.

Layer 1 protocols define the physical (electrical, optical, or wireless) interface between nodes of the network. Layer 1 protocols include various Ethernet physical configurations, the Synchronous Optical Network (SONET) and other optical connection protocols, and various wireless protocols such as WIFI.

Layer 2 protocols govern how data is logically transferred between nodes of the network. Layer 2 protocols include the Ethernet, Asynchronous Transfer Mode (ATM), Frame Relay, and Point to Point Protocol (PPP).

Layer 3 protocols govern how packets are routed from a source to a destination along paths connecting multiple nodes of the network. The dominant layer 3 protocols are the well-known Internet Protocol version 4 (IPv4) and version 6 (IPv6). A packet switched network may need to route IP packets using a mixture of the Ethernet, ATM, FR, and/or PPP layer 2 protocols. At least some of the nodes of the network may include a router that extracts a destination address from a network layer header contained within each packet. The router then used the destination address to determine the route or path along which the packet should be retransmitted. A typical packet may pass through a plurality of routers, each of which repeats the actions of extracting the destination address and determining the route or path along which the packet should be retransmitted.

In order to test a packet switched network or a device included in a packet switched communications network, test traffic comprising a large number of packets may be generated, transmitted into the network at one or more ports, and received at different ports. Each packet in the test traffic may be a unicast packet intended for reception at a specific destination port or a multicast packet, which may be intended for reception at two or more destination ports. In this context, the term “port” refers to a communications connection between the network and the equipment used to test the network. The term “port unit” refers to a module with the network test equipment that connects to the network at a port. The received test traffic may be analyzed to measure the performance of the network. Each port unit connected to the network may be both a source of test traffic and a destination for test traffic. Each port unit may emulate a plurality of logical source or destination addresses. The number of port units and the communications paths that connect the port units to the network are typically fixed for the duration of a test session. The internal structure of the network may change during a test session, for example due to failure of a communications path or hardware device.

A series of packets originating from a single port unit and having a specific type of packet and a specific rate will be referred to herein as a “stream.” A source port unit may support multiple outgoing streams simultaneously and concurrently, for example to accommodate multiple packet types, rates, or destinations. “Simultaneously” means “at exactly the same time.” “Concurrently” means “within the same time.”

For the purpose of collecting test data, the test traffic may be organized into packet groups, where a “packet group” is any plurality of packets for which network traffic statistics are accumulated. The packets in a given packet group may be distinguished by a packet group identifier (PGID) contained in each packet. The PGID may be, for example, a dedicated identifier field or combination of two or more fields within each packet.

For the purpose of reporting network traffic data, the test traffic may be organized into flows, where a “flow” is any plurality of packets for which network traffic statistics are reported. Each flow may consist of a single packet group or a small plurality of packet groups. Each packet group may typically belong to a single flow.

Within this description, the term “engine” means a collection of hardware, which may be augmented by firmware and/or software, which performs the described functions. An engine may typically be designed using a hardware description language (HDL) that defines the engine primarily in functional terms. The HDL design may be verified using an HDL simulation tool. The verified HDL design may then be converted into a gate netlist or other physical description of the engine in a process commonly termed “synthesis”. The synthesis may be performed automatically using a synthesis tool. The gate netlist or other physical description may be further converted into programming code for implementing the engine in a programmable device such as a field programmable gate array (FPGA), a programmable logic device (PLD), or a programmable logic arrays (PLA). The gate netlist or other physical description may be converted into process instructions and masks for fabricating the engine within an application specific integrated circuit (ASIC).

Within this description, the term “logic” also means a collection of hardware that performs a described function, which may be on a smaller scale than an “engine”. “Logic” encompasses combinatorial logic circuits; sequential logic circuits which may include flip-flops, registers and other data storage elements; and complex sequential logic circuits such as finite-state machines.

Within this description, a “unit” also means a collection of hardware, which may be augmented by firmware and/or software, which may be on a larger scale than an “engine”. For example, a unit may contain multiple engines, some of which may perform similar functions in parallel. The terms “logic”, “engine”, and “unit” do not imply any physical separation or demarcation. All or portions of one or more units and/or engines may be collocated on a common card, such as a network card 106, or within a common FPGA, ASIC, or other circuit device.

### DESCRIPTION OF THE DRAWINGS

FIG. 1 is a block diagram of a network environment.

FIG. 2 is a block diagram of a port unit.

FIG. 3 is a block diagram of a traffic generator.

FIG. 4 is a block diagram of traffic generator showing flow control logic.

FIG. 5 is a view of a graphical user interface.

FIG. 6 is a flow chart of a process for generating traffic.

Throughout this description, elements appearing in block diagrams are assigned three-digit reference designators, where the most significant digit is the figure number and the two least significant digits are specific to the element. An element that is not described in conjunction with a block diagram may be presumed to have the same characteristics and function as a previously-described element having a reference designator with the same least significant digits.

In block diagrams, arrow-terminated lines may indicate data paths rather than signals. Each data path may be multiple bits in width. For example, each data path may consist of 4, 8, 16, 64, 256, or more parallel connections.

### DETAILED DESCRIPTION

Description of Apparatus

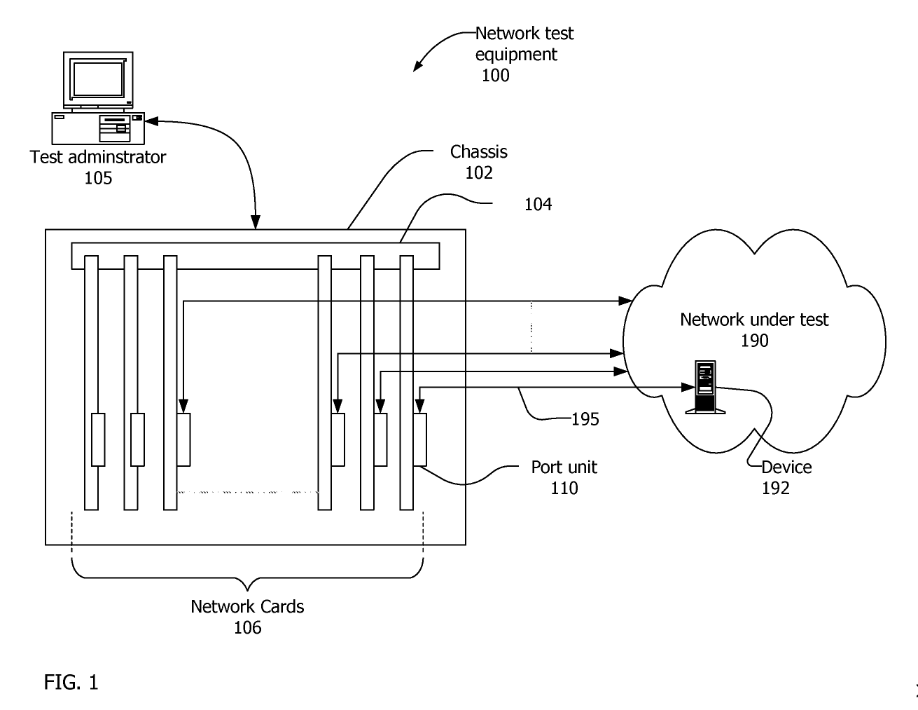

FIG. 1 shows a block diagram of a network environment. The environment may include network test equipment 100, a network 190 and plural network devices 192.

The network test equipment 100 may be a network testing device, performance analyzer, conformance validation system, network analyzer, or network management system. The network test equipment 100 may include one or more network cards 106 and a backplane 104 contained or enclosed within a chassis 102. The chassis 102 may be a fixed or portable chassis, cabinet, or enclosure suitable to contain the network test equipment. The network test equipment 100 may be an integrated unit, as shown in FIG. 1. Alternatively, the network test equipment 100 may comprise a number of separate units cooperative to provide traffic generation and/or analysis. The network test equipment 100 and the network cards 106 may support one or more well known standards or protocols such as the various Ethernet and Fibre Channel standards, and may support proprietary protocols as well.

The network cards 106 may include one or more field programmable gate arrays (FPGAs), application specific integrated circuits (ASICs), programmable logic devices (PLDs), programmable logic arrays (PLAs), processors and other kinds of devices. In addition, the network cards 106 may include software and/or firmware. The term network card encompasses line cards, test cards, analysis cards, network line cards, load modules, interface cards, network interface cards, data interface cards, packet engine cards, service cards, smart cards, switch cards, relay access cards, and the like. The term network card also encompasses modules, units, and assemblies that may include multiple printed circuit boards. Each network card 106 may contain one or more port unit 110. Each port unit 110 may connect to the network 190 through one or more ports. The port units 110 may be connected to the network 190 through a communication medium 195, which may be a wire, an optical fiber, a wireless link, or other communication medium. Each network card 106 may support a single communications protocol, may support a number of related protocols, or may support a number of unrelated protocols. The network cards 106 may be permanently installed in the network test equipment 100 or may be removable.

The backplane 104 may serve as a bus or communications medium for the network cards 106. The backplane 104 may also provide power to the network cards 106.

The network devices 192 may be any devices capable of communicating over the network 190. The network devices 192 may be computing devices such as workstations, personal computers, servers, portable computers, personal digital assistants (PDAs), computing tablets, cellular/mobile telephones, e-mail appliances, and the like; peripheral devices such as printers, scanners, facsimile machines and the like; network capable storage devices including disk drives such as network attached storage (NAS) and storage area network (SAN) devices; networking devices such as routers, relays, hubs, switches, bridges, and multiplexers. In addition, the network devices 192 may include appliances, alarm systems, and any other device or system capable of communicating over a network.

The network 190 may be a Local Area Network (LAN), a Wide Area Network (WAN), a Storage Area Network (SAN), wired, wireless, or a combination of these, and may include or be the Internet. Communications on the network 190 may take various forms, including frames, cells, datagrams, packets or other units of information, all of which are referred to herein as packets. The network test equipment 100 and the network devices 192 may communicate simultaneously with one another, and there may be plural logical communications paths between the network test equipment 100 and a given network device 195. The network itself may be comprised of numerous nodes providing numerous physical and logical paths for data to travel.

Each port unit 110 may be connected, via a specific communication link 195, to a corresponding port on a network device 192. In some circumstances, the port unit 110 may send more traffic to the corresponding port on the network device 192 than the network device 192 can properly receive. For example, the network device 192 may receive incoming packets from a plurality of sources at a total rate that is faster than the rate at which the network device 192 can process and forward the packets. In this case, buffer memories within the network device 192 may fill with received but unprocessed packets. To avoid losing packets due to buffer memory overflow, the network device 192 may send a flow control message or packet to the port unit 110.

For example, if the port unit 110 and the network device 192 communicate using a full-duplex Ethernet connection, IEEE Standard 802.3x provides that the network device 192 may send a pause frame or packet to the port unit 110. The pause frame may instruct the port unit 110 to stop sending packets, except for certain control packets, for a time period defined by data within the pause packet. The network device 192 may also send a pause packet defining a time period of zero to cause a previously-paused port unit to resume transmitting packets.

However, simply pausing the output from a port unit may not be an acceptable method of flow control in networks that prioritize traffic in accordance with quality of service (QoS) levels, traffic classes, or some other priority scheme. For example, IEEE Standard 802.1Qbb provides that a receiver may control the flow of eight traffic classes. To affect flow control, the receiver may send a priority flow control packet to the transmitter instructing that any or all of eight traffic classes be paused. The priority flow control packet may also define the period for which each traffic class is paused independently.

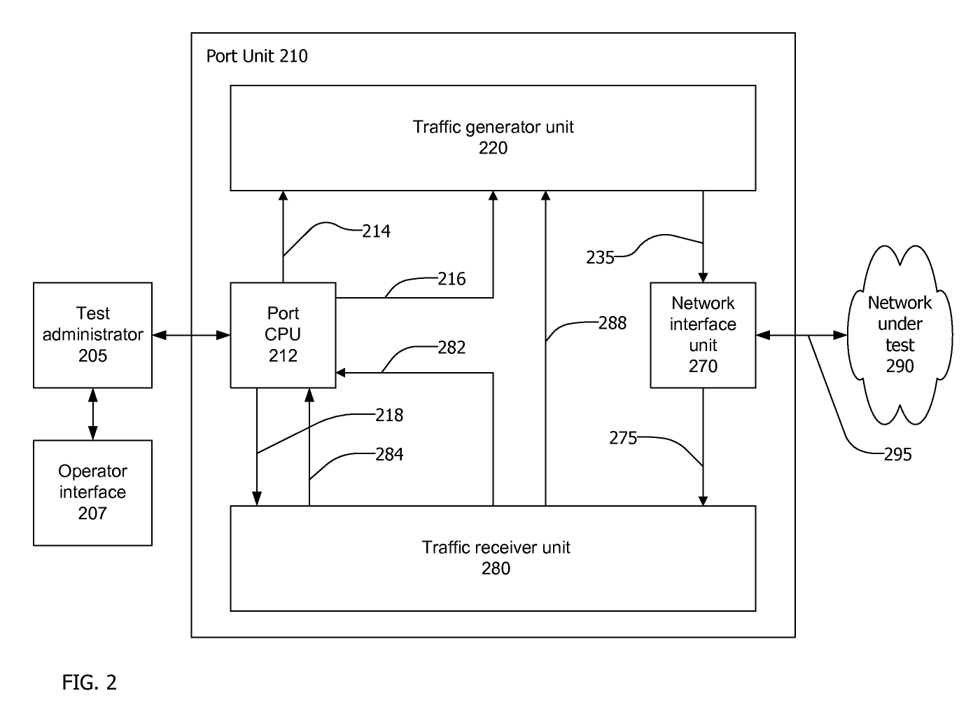

Referring now to FIG. 2, an exemplary port unit 210 may include a port processor 212, a traffic generator unit 220, a traffic receiver unit 280, and a network interface unit 270 which couples the port unit 210 to a network under test 290. The port unit 210 may be all or part of a network card such as the network cards 106.

The port processor 212 may include a processor, a memory coupled to the processor, and various specialized units, circuits, software and interfaces for providing the functionality and features described here. The processes, functionality and features may be embodied in whole or in part in software which operates on the processor and may be in the form of firmware, an application program, an applet (e.g., a Java applet), a browser plug-in, a COM object, a dynamic linked library (DLL), a script, one or more subroutines, or an operating system component or service. The hardware and software and their functions may be distributed such that some functions are performed by the processor and others by other devices.

The port processor 212 may communicate with a test administrator 205. The test administrator 205 may be a computing device contained within, or external to, the network test equipment 100. The test administrator 205 may provide the port processor 212 with instructions and data required for the port unit to participate in testing the network 290. The instructions and data received from the test administrator 205 may include, for example, definitions of packet streams to be generated by the port unit 210 and definitions of performance statistics that may be accumulated and reported by the port unit 210.

The port processor 212 may provide the traffic generator unit 220 with stream forming data 214 to form a plurality of streams. The stream forming data 214 may include, for example, the type of packet, the frequency of transmission, definitions of fixed and variable-content fields within the packet and other information for each packet stream. The traffic generator unit 220 may then generate the plurality of streams in accordance with the stream forming data 214. The plurality of streams may be interleaved to form outgoing test traffic 235. Each of the streams may include a sequence of packets. The packets within each stream may be of the same general type but may vary in length and content.

The network interface unit 270 may convert the outgoing test traffic 235 from the traffic generator unit 220 into the electrical, optical, or wireless signal format required to transmit the test traffic to the network under test 290 via a link 295, which may be a wire, an optical fiber, a wireless link, or other communication link. Similarly, the network interface unit 270 may receive electrical, optical, or wireless signals from the network over the link 295 and may convert the received signals into incoming test traffic 275 in a format usable to the traffic receiver unit 280.

The traffic receiver unit 280 may receive the incoming test traffic 275 from the network interface unit 270. The traffic receiver unit 280 may determine if each received packet is a member of a specific flow, and may accumulate test statistics for each flow in accordance with test instructions 218 provided by the port processor 212. The accumulated test statistics may include, for example, a total number of received packets, a number of packets received out-of-sequence, a number of received packets with errors, a maximum, average, and minimum propagation delay, and other statistics for each flow. The traffic receiver unit 280 may also capture and store specific packets in accordance with capture criteria included in the test instructions 218. The traffic receiver unit 280 may provide test statistics and/or captured packets 284 to the port processor 212, in accordance with the test instructions 218, for additional analysis during, or subsequent to, the test session.

The outgoing test traffic 235 and the incoming test traffic 275 may be primarily stateless, which is to say that the outgoing test traffic 235 may be generated without expectation of any response and the incoming test traffic 275 may be received without any intention of responding. However, some amount of stateful, or interactive, communications may be required or desired between the port unit 210 and the network 290 during a test session. For example, the traffic receiver unit 280 may receive control packets, which are packets containing data necessary to control the test session, that require the port unit 210 to send an acknowledgement or response.

The traffic receiver unit 280 may separate incoming control packets from the incoming test traffic and may route the incoming control packets 282 to the port processor 212. The port processor 212 may extract the content of each control packet and may generate an appropriate response in the form of one or more outgoing control packets 216. Outgoing control packets 216 may be provided to the traffic generator unit 220. The traffic generator unit 220 may insert the outgoing control packets 216 into the outgoing test traffic 235.

The outgoing test traffic 235 from the traffic generator unit 220 may be divided into “flow control groups” which may be independently paused. Each stream generated by the traffic generator unit 220 may be assigned to one and only one flow control group, and each flow control group may include none, one, or a plurality of streams. One form of control packet that may be received by the port unit 220 may be flow control packets 288, which may be, for example, in accordance with IEEE 802.1Qbb. Flow control packets 288 may be recognized within the traffic receiver unit 280 and may be provided directly from the traffic receiver unit 280 to the traffic generator unit 220.

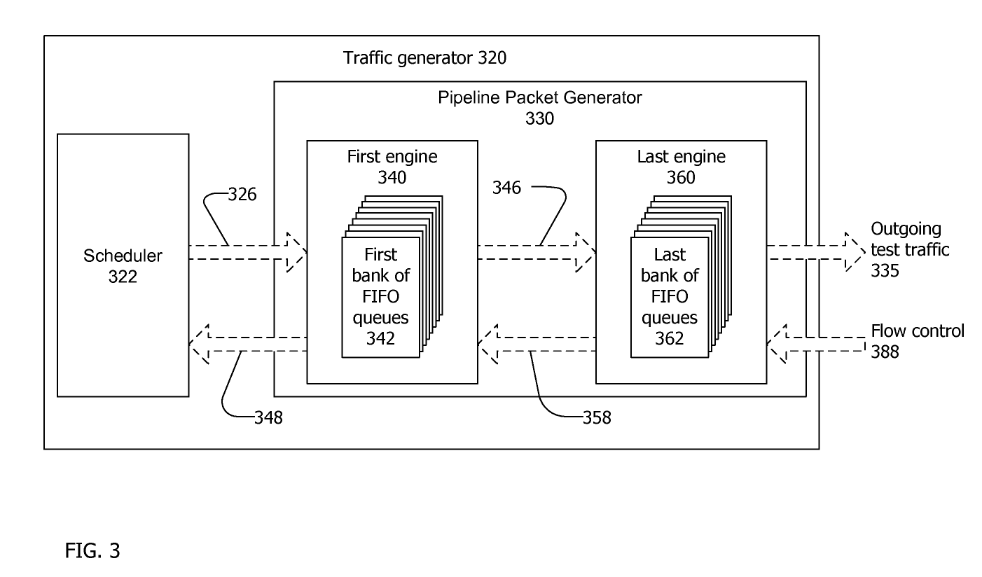

Referring now to FIG. 3, an exemplary traffic generator 320 may generate outgoing test traffic 335 composed of a plurality of interleaved streams of packets. The traffic generator may be capable of generating, for example, 16 streams, 64 streams, 256 streams, 512 streams, or some other number streams which may be interleaved in any combination to provide the test traffic. The exemplary traffic generator 320 may be the traffic generator unit 220 of FIG. 2 and may be all or a portion of a network card 106 as shown in FIG. 1.

The traffic generator 320 may include a scheduler 322 and a packet generator 330. The scheduler may determine a sequence in which packets should be generated based upon stream forming data for a plurality of stream. For example, the scheduler 322 may schedule a plurality of streams. A desired transmission rate may be associated with each stream. The scheduler 322 may include a timing mechanism for each stream to indicate when each stream should contribute a packet to the test traffic. The scheduler 322 may also include arbitration logic to determine the packet sequence in situations when two or more stream should contribute packets at the same time. The scheduler 322 may be implemented in hardware or a combination of hardware and software. For example, U.S. Pat. No. 7,616,568 B2 describes a scheduler using linked data structures and a single hardware timer. Pending application Ser. No. 12/496,415 describes a scheduler using a plurality of hardware timers.

For each packet to be generated, the scheduler 322 may provide the packet generator 330 with first packet forming data 326. In this patent, the term “packet forming data” means any data necessary to generate a packet. Packet forming data may include data identifying a type, length, or other characteristic of a packet to be formed. Packet forming data may include fragments, fields, or portion of packets, and incompletely formed packets. Completed, transmission-ready packets are not considered to be packet forming data. The first packet forming data 326 provided by the scheduler 322 to the pipeline packet generator 330 may include data identifying one stream of the plurality of streams. To allow priority flow control, the first packet forming data 326 may also include data identifying a flow control group associated with the identified stream. The first packet forming data 326 may include other data necessary to form each packet.

The actions required by the packet generator 330 to generate a packet may include defining a packet format, which may be common to all packets in a stream, and determining a packet length. The packet generator 330 may generate content for a payload portion of each packet. The packet generator 330 may generate other content specific to each packet, which may include, for example, source and destination addresses, sequence numbers, port numbers, and other fields having content that varies between packets in a stream. The packet generator 330 may also calculate various checksums and a frame check sequence, and may add a timestamp to each packet. The time required to generate a packet may be longer than the time required for transmission of the packet. To allow continuous transmission of test traffic, multiple packets may have to be generated simultaneously. Thus the packet generator 330 may be organized as a pipeline including two or more processing engines that perform sequential stages of a packet generation process. At any given instant, each processing engine may be processing different packets, thus providing a capability to generate a plurality of packets simultaneously.

The pipeline packet generator 330 may include a first processing engine 340 and a last processing engine 360 and, optionally, one or more intermediate processing engines which are not shown in FIG. 3. The first processing engine 340 may input first packet forming data 326 from the scheduler 322 and may output intermediate packet forming data 346. The intermediate packet forming data may flow through and be modified by intermediate processing engines, if present. Each intermediate processing engine may receive packet forming data from a previous processing engine in the pipeline and output modified packet forming data to a subsequent processing engine in the pipeline. The packet forming data may be modified and expanded at each processing engine in the pipeline. The last processing engine 360 may receive intermediate packet forming data 346 from a previous processing engine and may output a sequence of completed packets as test traffic 335.

The time required for the first processing engine 340, the last processing engine 360, and any intermediate processing engines (not shown) to process a specific packet may depend on characteristics of the specific packet, such as the number of variable-content fields to be filled, the length of the payload to be filled, and the number and scope of checksums to be calculated. The time required to process a specific packet may be different for each processing engine. At any given processing engine, the time required to process a specific packet may not be the same as the time required to process the previous or subsequent packets.

A pipeline packet generator may include first-in first-out (FIFO) buffer memories or queues to regulate the flow of packet forming data between or within stages of the pipeline. In the example of FIG. 3, the first processing engine includes a first bank of FIFO queues 342 and the last processing engine 360 includes a last bank of FIFO queues 362. Any intermediate processing engines (not shown) may also include banks of FIFO queues. The banks of FIFO queues 342, 362 may not store completed packets, but may be adapted to store packet forming data appropriate for the respective stage of the packet forming process.

To allow priority flow control of the outgoing test traffic 325, at least some of the banks of FIFO queues with a pipeline packet generator may include parallel FIFO queues corresponding to a plurality of flow control groups. Providing separate FIFO queues for each flow control group may allow packets for flow control groups that are not paused to pass packets from paused flow control groups within the pipeline packet processor 330.

The pipeline packet generator 330 may receive flow control data 388, which may be based on flow control packets received from a network under test. The flow control data may be or include a plurality of bits indicating whether or not respective groups of the plurality of flow control groups are paused. When the pipeline packet generator 330 receives flow control data indicating that one or more flow control groups should be paused, the pipeline packet generator 330 may stop outputting packet streams associated with the one or more paused flow control groups. If the flow control data 388 changes while a packet is being output from the pipeline packet generator 330, the transmission of the packet may be completed before the associated flow control group is paused.

Flow control data may propagate through the pipeline packet generator 330 in the reverse direction to the flow of packet forming data. The last processing engine 360 may receive flow control data 388 and provide intermediate flow control data 358 to a previous engine in the pipeline packet processor 330. The intermediate flow control data 358 may not directly indicate if specific flow control groups are paused, but may indicate if specific FIFO queues in the last bank of FIFO queues 362 are considered full. A FIFO queue considered full may not be completely filled, but may be unable to accept additional packet forming data from the previous processing engine. A FIFO queue may be considered full if the amount of data stored in the queue exceeds a predetermined portion its capacity.

The first processing engine 340 and the intermediate processing engines, if present, may continue processing packets for each flow control group until they receive intermediate flow control data 358 indicating that one or more FIFO queues in the subsequent processing engine are considered full. The first processing engine 340 and the intermediate processing engines may stop processing packet streams associated with one or more specific flow control groups if the corresponding FIFO queues in the subsequent processing engine are unable to accept additional packet forming data.

The first process engine 340 may provide scheduler flow control data 348 to the scheduler 322. The scheduler flow control data 348 may indicate that one or more FIFO queues in the first bank of FIFO queues 342 are considered full. The scheduler 322 may stop scheduling packet streams associated with one or more specific flow control groups if the scheduler flow control data 348 indicates that corresponding FIFO queues in the first processing engine 340 are unable to accept additional packet forming data.

Propagating flow control data through the pipeline packet generator 330 as described may ensure that, when a previously-paused flow control group is reactivated, transmission of packet streams associated with the previously-paused flow control group can be resumed immediately, without waiting for the pipeline to refill. Additionally, propagating flow control data through the pipeline packet generator 330 as described may allow the transmission of packet streams associated with the previously-paused flow control group to resume without skipping or dropping any packets within the pipeline packet generator.

The number of flow control groups, and the corresponding number of parallel FIFO queues in each bank of FIFO queues, may be equal to or greater than a desired number of independently controllable traffic classes. Based on current standards, each of the banks of FIFO queues 342, 362 would preferably include 8 or more parallel FIFO queues to accommodate eight traffic classes as required by IEEE Standard 802.1Qbb. However, in some circumstances, the number of FIFO queues in each bank may not be equal to or greater than the desired number of flow control traffic classes. For example, hardware or cost limitations may limit the number of FIFO queues in each bank to less than the number of traffic classes. For further example, a traffic generator configured with eight FIFO queues per bank for compatibility with today's standard (IEEE 802.1Qbb) may not be compatible with a future standard requiring more than eight controllable traffic classes.

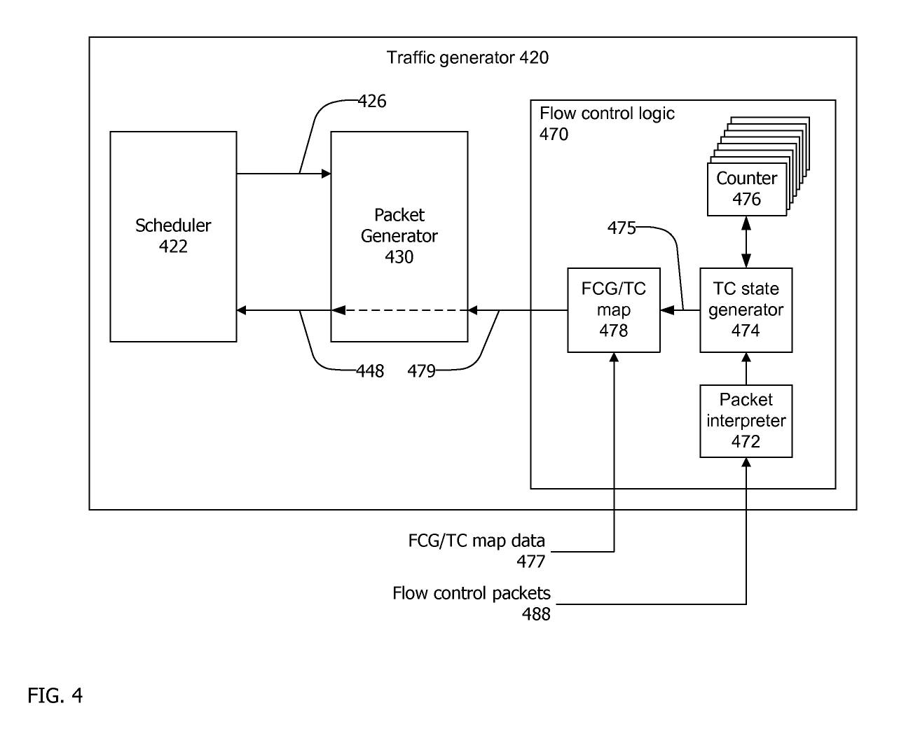

Referring now to FIG. 4, a traffic generator 420, which may be the traffic generator 320, may include a scheduler 422, a packet generator 430, and flow control logic 470. The flow control logic 470 may include a packet interpreter 472, a traffic class state generator 474, a bank of counter timers 476, and a FCG/TC map memory 478. The packet interpreter 472 may receive flow control packets 488 from a traffic receiver (not shown) and may extract flow control information from each packet. The extracted flow control information may include information instructing the traffic generator 420 to pause one or more traffic classes of a plurality of traffic classes and/or to resume transmitting one or more traffic classes. Some traffic classes may be unaffected by the received flow control packet. The extracted flow control information may further include, for each traffic class to be paused, a pause time interval.

The bank of timers 476 may include a plurality of timers corresponding to the plurality of traffic classes. When a received flow control packet contains flow control information instructing that transmission of packets for a traffic class should be paused for a specified time interval, the respective timer may be used to resume transmission of the traffic class when the specified time interval has elapsed. For example, the timer may be set to the specified time interval when the flow control packet is received and may count down to zero, at which time the transmission of the traffic class may be automatically resumed.

The traffic class state generator 474 may combine flow control information extracted by the packet interpreter 472 and the values of the plurality of timers 476 to generate traffic class state data 475. The traffic class state data 475 may define a state of each traffic class. For example, the traffic class state generator 474 may be a finite state machine that maintains a state for each of the plurality of traffic classes. Current flow control protocols such as IEEE Standards 802.3x and 802.1Qbb only define paused and not paused (or active) traffic states. In this case, the traffic class state data 475 may be a plurality of bits corresponding to the plurality of traffic classes, with each bit indicating the paused/not paused state of the respective traffic class. Future flow controls protocols may define additional traffic states (for example, flow restricted but not paused), in which case the traffic class state data may require more than one bit per traffic class.

The traffic class state data 475 may be applied to the FCG/TC map 478 to generate first flow control data 479. For example, the FCG/TC map 478 may be a memory, wherein the number of address bits is equal to the number of traffic classes, and the number of data bits is equal to the number of flow control groups. The traffic class state data 475 may be used as an address to read the first flow control data 472 from the FCG/TC map memory. The first flow control data 479 may include a plurality of bits corresponding to the plurality of flow control groups, with each bit indicating a paused/not paused state of the respective flow control group.

The FCG/TC map 478 may map each traffic class to none, one, or more flow control groups. An instruction to pause a traffic class may cause the traffic generator 420 to stop transmitting packet streams associated with all flow control groups mapped to the paused traffic class. Similarly, each flow control group may be mapped to none, one, or more traffic classes. The traffic generator 420 may stop transmitting packet streams associated with a given flow control group if any one of the traffic classes mapped to the given flow control group is paused.

FCG/TC map data 477 may be stored in the FCG/TC map 478 by a processor (not shown) such as the port CPU 212 or the test administrator 205. FCG/TC map data 477 may be initially stored in the FCG/TC map 478 prior to the start of a test session. FCG/TC map data 477 may also be stored in the FCG/TC map 478 during a test session to dynamically change the associations between traffic classes and flow control groups.

Flow control data may propagate through the packet generator 430 as previously described. When FIFO queues (not shown) within the packet generator 430 are considered full for one or more flow control groups, the packet generator 430 may provide scheduler flow control data 448 to the scheduler 422. The scheduler flow control data 448 may be, for example, a plurality of bits corresponding to the plurality of flow control groups, with each bit indicating whether or not the scheduler 422 should suspend scheduling packets streams associated with the respective flow control group.

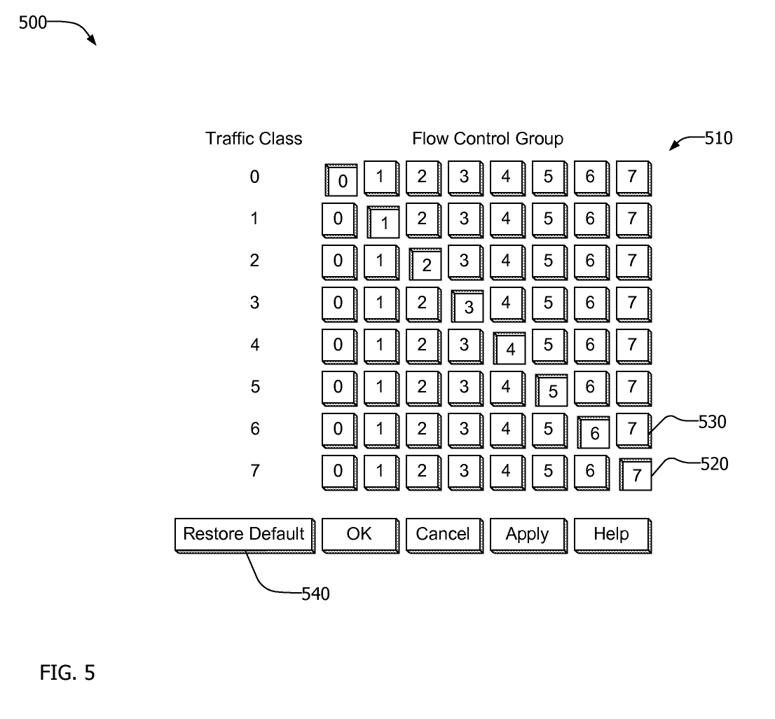

FIG. 5 illustrates an exemplary user interface 500 for mapping a plurality of traffic classes to a plurality of flow control groups. In the example, eight traffic classes, numbered 0 to 7, may be mapped to eight flow control groups, also numbered 0 to seven, by an 8×8 array 510 of keys such as keys 520 and 530. The number of traffic classes may be more or fewer than eight, and the number of flow control groups may also be more or fewer than eight. The number of flow control groups may or may not be equal to the number of traffic classes.

Each row of the array 510 may be associated with a traffic class, and each column of the array may be associated with a flow control group. A key located at the intersection of each row and column may determine if the associated flow control group is mapped to the associated traffic class. In the example of FIG. 5, the key 520 is depressed indicating that flow control group 7 may be paused when an instruction to pause traffic class 7 is received. The key 530 is not depressed indicating that flow control group 7 may not be paused when an instruction to pause traffic class 6 is received.

As shown in FIG. 5, each traffic class is mapped to a single corresponding flow control group. This may be a default configuration selectable by a “Restore Default” key 540. It may be understood that the array 510 may be used to map flow control groups to traffic classes in any combination. Each flow control group may be mapped to none, one, several, or all of the plurality of traffic classes, and each traffic class may be mapped to none, one, several, or all of the plurality of flow control groups. The user interface 500 may include other control keys such as the “OK”, “Cancel”, “Apply” and “Help” keys which have conventional functions.

The user interface 500 may be implemented as a graphical user interface (GUI), in which case the keys may be virtual keys shown on a display screen. In this case, operator activation of individual keys may be detected by a touch panel superimposed on the display screen. Operator activation of individual keys may be performed using a pointing device such as a mouse. The user interface 500 may be implemented, in whole or in part, by mechanical keys or buttons rather than virtual keys.

Description of Processes

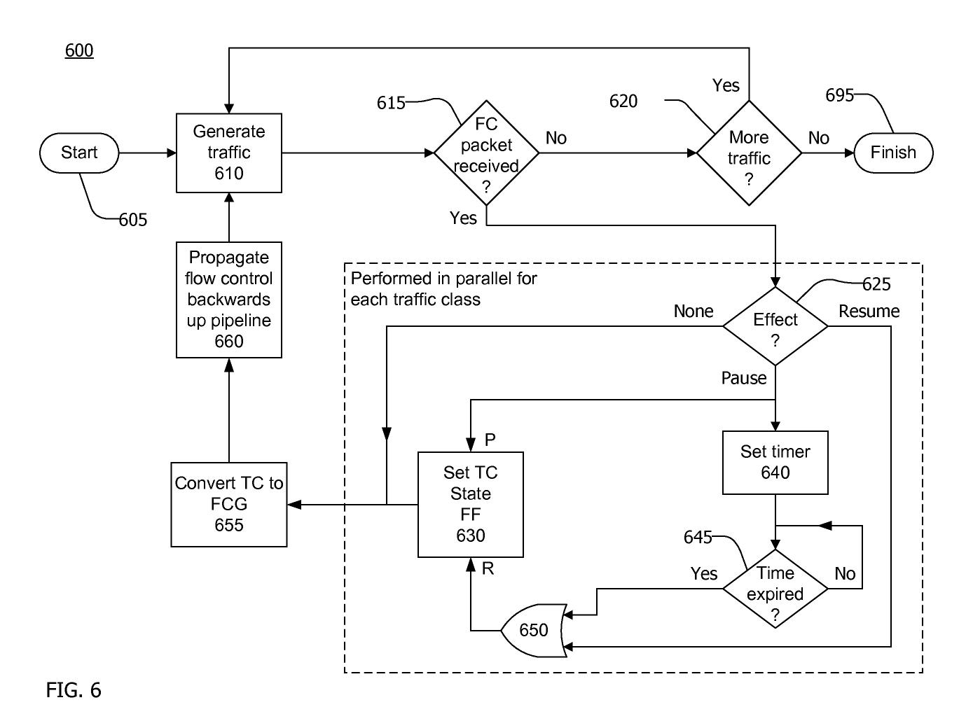

Referring now to FIG. 6, a process 600 for generating traffic may start at 605 and may end at 695 after a large number of packets have been generated, or when stopped by an operator action (not shown in FIG. 6). The process 600 may be appropriate for generating traffic using a traffic generator, such as the traffic generator 320. The process 600 may be cyclic and real-time in nature. The flow chart of FIG. 6 shows the process 600 as performed by a single port unit. It should be understood that the process 600 may be performed simultaneously by a plurality of port units in parallel during a test session.

Prior to the start 605 of the process 600, a test session may have been designed. The test session design may be done, for example, by an operator using a test administrator computing device, such as the test administrator 205, coupled to one or more port units, such as the port unit 210. Designing the test session may include determining or defining the architecture of the network or network equipment, defining streams to be generated by each port unit during the test session, creating corresponding stream forming data, and forwarding respective stream forming data to at least one port unit.

Designing the test session may also include defining a plurality of flow control groups (FCGs) and associating each stream with one and only one FCG. FCG map data defining the associations between streams and FCGs may be provided to each port unit. For example, the FCG map data may be written into an FCG map memory within each port unit. Designing the test session may also include defining a plurality of traffic classes and associating each traffic class with one or more flow control groups. FCG/TC map data defining the associations between FCGs and traffic classes may be provided to each port unit. For example, the FCG/TC map data may be written into an FCG/TC map memory, such as the memory 478, within each port unit.

The FCG map data may be dynamic, which is to say that data may be written to the FCG map memory during a test session to change the associations between streams and flow control groups. Similarly, the FCG/TC map data may be dynamic and data may be written to the FCG/TC map memory during a test session to change the associations between flow control groups and traffic classes.

At 610, the traffic generator may generate traffic by forming and transmitting a packet. At 615, a determination may be made whether or not a flow control (FC) packet has been received. When a flow control packet has not been received, a determination may be made at 620 whether or not there are more packets to be generated. If there are no more packets to be generated, the test session may finish at 695. When there are more packets to be generated, the process may repeat from 610. Although the actions at 610, 615, and 620 are shown to be sequential for ease of explanation, these actions may be performed concurrently. The actions from 610 to 620 may be repeated essentially continuously for the duration of a test session.

When a determination is made at 615 that a flow control packet has been received, the actions from 625 to 650 may be performed independently and in parallel for each of the plurality of traffic classes. At 625, a determination may be made if the received flow control packet affects a specific traffic class. For example, the flow control packet may contain an N-bit mask, where N is the number of traffic classes, indicating whether or not each traffic class is affected by the packet. The flow control packet may contain additional information indicating if transmission of each affected traffic class is paused or resumed. The flow control packet may also contain information indicating a pause duration for each paused traffic class.

For example, a priority flow control packet in accordance with IEEE 802.1Qbb contains an eight-bit mask, where a bit value of 0 indicates the packet does not affect the status of a respective traffic class and a bit value of 1 indicates that the packet pauses the respective traffic class. A priority flow control packet in accordance with IEEE 802.1Qbb also contains a pause duration for each paused traffic class, where a pause duration of zero indicates that a previously paused traffic class should be resumed.

At 625, a determination may be made that a received flow control packet contains instructions to pause a specific traffic class, to resume transmission of the specific traffic class, or has no effect (none) on the specific traffic class. When a determination is made at 625 that the received flow control packet contains instructions to pause a specific traffic class, a traffic class state for that traffic class may be set accordingly at 630. For example, the traffic class state for the traffic class may be stored in a respective flip-flop which may be set or reset at 630 in accordance with the received flow control packet.

When a determination is made at 625 that the received flow control packet contains instructions to pause a specific traffic class for a specified time interval, a timer may be set at 640 to track the time remaining in the specified time interval. When a determination is made at 645 that the specified time interval has elapsed, the traffic class state may reset at 630 (via OR function 650). When a determination is made at 625 that the received flow control packet contains instructions to resume transmission of a flow control group, the traffic class state may reset at 630 (via OR function 650).

When the traffic class states are set for all of the plurality of traffic classes in accordance with the received flow control packet, the traffic class states may be converted to flow control data for a plurality of flow control groups at 655. For example, the traffic class state data may be applied to a FCG/TC map memory or look-up table to convert the traffic class state data to flow control data for the plurality of flow control groups. At 660, the flow control data may propagate backwards (in the reverse direction of the flow of packet forming data) up the pipeline to cause the traffic generator to stop generating packets for paused flow control groups in an orderly manner, such that no packets are dropped within the traffic generator and such that the transmission of packets may be resumed without waiting for the pipeline to refill.

The process 600 may return to 610 to generate test traffic in accordance with the flow control data from 655. The process 600 may continue to generate test traffic in accordance with the flow control data from 655 until the test session is completed at 696, or until a new flow control packet is received.

Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. An apparatus for testing a network, comprising:
a traffic receiver to receive flow control packets from the network
a traffic generator to generate test traffic and transmit the test traffic over the network, the test traffic including a plurality of packet streams associated with a plurality of flow control groups (FCGs), the traffic generator including:
flow control logic to maintain traffic class (TC) state data indicating a paused/not paused state for each of a plurality of traffic classes in accordance with the received flow control packets
a TC/FCG map to convert the traffic class state data into flow control data indicating a paused/not paused state for each of the plurality of flow control groups
wherein the traffic generator is configured to pause transmission of all packet streams associated with paused flow control groups in accordance with the flow control data.

2. The apparatus for testing a network of claim 1, wherein the TC/FCG map is a first memory to store TC/FCG conversion data.

3. The apparatus for testing a network of claim 2, further comprising:
a processor coupled to the first memory and to an operator interface
wherein the processor receives TC/FCG conversion data via the operator interface and stores the received TC/FCG conversion data in the first memory.

4. The apparatus for testing a network of claim 3, wherein the processor stores TC/FCG conversion data in the first memory dynamically during a test session.

5. The apparatus for testing a network of claim 1, wherein the plurality of traffic classes includes 8 traffic classes in accordance with IEEE Standard 802.1Qbb.

6. The apparatus for testing a network of claim 5, wherein the plurality of flow control groups includes fewer than 8 flow control groups.

7. The apparatus for testing a network of claim 1, wherein the plurality of flow control groups includes 8 flow control groups.

8. The apparatus for testing a network of claim 1, wherein the flow control logic further comprises:
a plurality of timers to control a pause duration for respective traffic classes in accordance with the received flow control packets.

9. A method to test a network, comprising:
a traffic generator generating test traffic, the test traffic including a plurality of packet streams associated with a plurality of flow control groups
the traffic generator transmitting the test traffic over the network
a traffic receiver coupled to the traffic generator receiving flow control packets from the network
maintaining traffic class state data indicating a paused/not paused state for each of a plurality of traffic classes in accordance with the received flow control packets
mapping the traffic class state data into flow control data indicating a paused/not paused state for each of the plurality of flow control groups
stopping transmission of all packet streams associated with paused flow control groups in accordance with the flow control data.

10. The method to test a network of claim 9, wherein mapping the traffic class state data into flow control data is based on conversion data stored in a first memory.

11. The method to test a network of claim 10, further comprising:
a processor receiving conversion data from an operator interface and storing the received conversion data in the first memory.

12. The method to test a network of claim 11, wherein the processor stores conversion data in the first memory dynamically during a test session.

13. The method to test a network of claim 9, wherein the plurality of traffic classes includes 8 traffic classes in accordance with IEEE Standard 802.1Qbb.

14. The method to test a network of claim 13, wherein the plurality of flow control groups includes fewer than 8 flow control groups.

15. The method to test a network of claim 9, wherein the plurality of flow control groups includes 8 flow control groups.

16. The method to test a network of claim 9, further comprising controlling a respective pause duration for each paused traffic class in accordance with the received flow control packets.

17. A machine-readable storage medium storing configuration data which, when used to program a programmable device, causes the programmable device to be configured as an apparatus to test a network, comprising:
a traffic receiver to receive flow control packets from the network
a traffic generator to generate test traffic and transmit the test traffic to the network, the test traffic including a plurality of packet streams associated with a plurality of flow control groups (FCGs), the traffic generator including:
flow control logic to maintain traffic class (TC) state data indicating a paused/not paused state for each of a plurality of traffic classes in accordance with the received flow control packets
a TC/FCG map to convert the traffic class state data into flow control data indicating a paused/not paused state for each of the plurality of flow control groups
wherein the traffic generator is configured to pause transmission of all packet streams associated with paused flow control groups in accordance with the flow control data.

18. The machine-readable storage medium of claim 17, wherein the TC/FCG map is a first memory to store TC/FCG conversion data.

19. The machine-readable storage medium of claim 17, wherein the plurality of traffic classes includes 8 traffic classes in accordance with IEEE Standard 802.1Qbb.

20. The machine-readable storage medium of claim 19, wherein the plurality of flow control groups includes fewer than 8 flow control groups.

21. The machine-readable storage medium of claim 17, wherein the plurality of flow control groups includes 8 flow control groups.

22. The machine-readable storage medium of claim 1, wherein the apparatus further comprises:
a plurality of timers to control a pause duration for respective traffic classes in accordance with the received flow control packets.
